(19) United States
(12) Patent Application Publication
(10) Pub. No.: US 2008/0060170 A1
(43) Pub. Date: Mar. 13, 2008

(54) Adjustable Clamp and Method For Use of Same

(76) Inventor: Fred A. Wagner, Ophir, CO (US)

Correspondence Address: SCOTT T. GRIGGS, 901 MAIN STREET, SUITE 6300, DALLAS, TX, 75202, US

(21) Appl. No.: 11/852,160

(22) Filed: Sep. 7, 2007

Related U.S. Application Data
(60) Provisional application No. 60/842,921, filed on Sep. 7, 2006.

(51) Int. Cl. F16G 11/14

(52) U.S. Cl. 24/129 R

(57) ABSTRACT

An adjustable clamp and method for use of the same are disclosed. In one embodiment, a tubular body having first and second openings disposed at respective first and second ends is adapted for accepting a flexible cord in an extended position therethrough. A v-shaped elongated slot is integrally formed from the tubular body such that a base of the v-shaped elongated slot intersects the first opening. The v-shaped elongated slot operably accepts the flexible cord in a folded position and when the flexible cord is displaced from the extended position to the folded position, an apex of the v-shaped elongated slot bites the flexible cord.

### PRIORITY STATEMENT & CROSS-REFERENCE TO RELATED APPLICATIONS

This application claims priority from co-pending U.S. Patent Application No. 60/842,921, entitled “Bungee Cord Stop” and filed on Sep. 7, 2006, in the name of Fred A. Wagner, III; which is hereby incorporated by reference for all purposes.

### TECHNICAL FIELD OF THE INVENTION

This invention relates, in general, to clamps and, in particular, to an adjustable clamp for use with a rope or flexible elastic cord that provides a variable length of rope or cord without the need for cutting.

### BACKGROUND OF THE INVENTION

Many times it is desirable to have variable length cords without cutting the cord to a shorter length or obtaining various lengths of separate cords. This is particularly true with respect to elastic stretchable cords such as bungee cords as the measure of usable cordage required varies with, for example, the dimensions of the cargo and applied tensioning force. A need therefore exists for a clamp, which is designed for use with flexible cords and particularly with bungee cords, that may readily and easily adjust the measure of usable cordage.

### SUMMARY OF THE INVENTION

An adjustable clamp and method for use of the same are disclosed. The adjustable clamp presented herein, which is designed for use with flexible cords and particularly with bungee cords, readily and easily adjusts the measure of usable cordage. In one embodiment, the adjustable clamp includes a tubular body having first and second openings disposed at respective first and second ends. The tubular body is adapted for accepting a flexible cord in an extended position therethrough. A v-shaped elongated slot is integrally formed from the tubular body such that a base of the v-shaped elongated slot intersects the first opening. The v-shaped elongated slot operably accepts the flexible cord in a folded position and when the flexible cord is displaced from the extended position to the folded position, an apex of the v-shaped elongated slot bites the flexible cord. It should be appreciated that other embodiments including methods for use of the adjustable clamp are disclosed herein.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a perspective view of one embodiment of an adjustable clamp having a flexible cord disposed therethrough in an extended position;

FIG. 2 is a perspective view of the adjustable clamp and flexible cord of FIG. 1 wherein the flexible cord is depicted in a folded position;

FIG. 3 is a side cross-sectional view of the adjustable clamp and flexible cord of FIG. 2 wherein the flexible cord is depicted in the folded position;

FIG. 4 is a front plan view of the adjustable clamp presented in FIG. 1;

FIG. 5 is a side plan view of the adjustable clamp presented in FIG. 1;

FIG. 6 is a rear plan view of the adjustable clamp presented in FIG. 1;

FIG. 7 is a top plan view of the adjustable clamp presented in FIG. 1;

FIG. 8 is a bottom plan view of the adjustable clamp presented in FIG. 1;

FIG. 9 is a perspective view of another embodiment of an adjustable clamp;

FIG. 10 is a perspective view of the adjustable clamp of FIG. 9 being utilized with a flexible cord;

FIG. 11 is a perspective view of the adjustable clamp with flexible cord of FIG. 10 securing cargo;

FIG. 12 is a perspective view of a further embodiment of an adjustable clamp;

FIG. 13 is a perspective view of a still further embodiment of an adjustable clamp;

FIG. 14 is a perspective view of another embodiment of an adjustable clamp;

FIG. 15 is a perspective view of one embodiment of an adjustable clamp system;

FIG. 16 is a perspective view of a double-barreled stop which is depicted in FIG. 15.

### DETAILED DESCRIPTION OF THE INVENTION

While the making and using of various embodiments of the present invention are discussed in detail below, it should be appreciated that the present invention provides many applicable inventive concepts which can be embodied in a wide variety of specific contexts. The specific embodiments discussed herein are merely illustrative of specific ways to make and use the invention, and do not delimit the scope of the present invention.

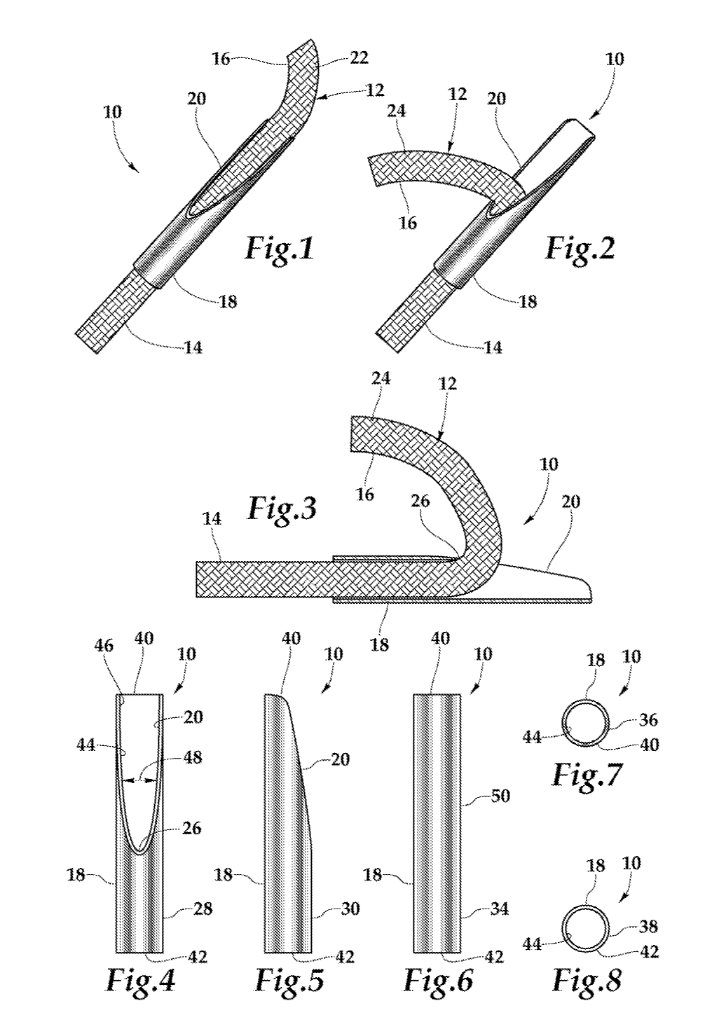

Referring initially to FIG. 1, therein is depicted one embodiment of an adjustable clamp that is schematically illustrated and generally designated 10. A flexible cord 12 includes a measure of usable cordage 14 and a measure of excess cordage 16, which may be referred to as a portion of the flexible cord 12. An open ended tubular body 18, which may be referred to as simply a tubular body 18, is adapted to accept the flexible cord 12 therethrough. A v-shaped elongated slot 20 is integrally formed from the tubular body 18 in order to releasably engage the flexible cord 12 therein, thereby reducing the measure of usable cordage 14.

As depicted in FIG. 1, the flexible cord 12 includes an extended position 22 that permits the flexible cord 12 to travel through the tubular body 16. In operation, the flexible cord 12 may be threaded through the tubular body 18 of the adjustable clamp 10. The measure of usable cordage 14 and the measure of excess cordage 16 provided may be adjusted by sliding or moving the flexible cord 12 through the tubular body 16.

With reference to FIG. 2 and continuing with the description of the operation of the combination of the adjustable clamp 10 and the flexible cord 12, the measure of excess cordage 16 may be folded upon itself proximate to the v-shaped elongated slot 20 from the extended position 22 to a folded position 24 as depicted in FIG. 2. The measure of excess cordage 16 may then releasably engage the v-shaped elongated slot 20, thereby fixing or restricting, and in some instances shortening, the measure of usable cordage 14. In one implementation, releasably engaging the measure of excess cordage 16 with the v-shaped elongated slot 20 may include pressing the measure of excess cordage 16 into the v-shaped elongated slot 20 such that the v-shaped elongated slot 20 bites the measure of excess cordage 16.

After use or to adjust the measures of usable cordage 14 and excess cordage 16, the flexible cord 12 may be released from the v-shaped elongated slot by sliding the flexible cord 12 out of the v-shaped elongated slot while substantially simultaneously opening the folded position 24, thereby returning the flexible cord 12 from the folded position 24 to the extended position 22 and freeing the movement of the flexible cord 12.

FIG. 3 depicts the adjustable clamp 10 and flexible cord 12 of FIG. 2 in the folded position 24. As shown, the v-shape elongated slot 20 releasably secures the flexible cord 12 against elongated movement at an apex 26 of the v-shaped elongated slot 20. With this arrangement, the flexible cord 12 pushed down into the v-shaped elongated slot 20 toward the apex 26 will be held therein by virtue of a friction fit. Should the flexible cord 12 have elastic properties, such as a bungee cord, once the flexible cord 12 is forced toward the apex 20 and through a narrowing span 48 (see FIG. 4), the flexible cord 12 will inherently expand to further increase the retention holding force on the flexible cord 12 in the v-shaped elongated slot 20. In this arrangement, the v-shaped elongated slot provides a groove for releasably gripping the flexible cord 12 therein. During use in the field, the gripping relationship may be increased as pulling the measure of usable cordage 14 increases the engagement between the measure of excess cordage 16 of the flexible cord 12 and the v-shaped elongated slot 20.

FIGS. 4 through 8 depict the adjustable clamp 10 in greater detail. The tubular body 18 includes a front 28, side 30, symmetrical side (substantially identical to the side 30), rear 34, top 36, and bottom 38. Openings 40, 42 at respective top 36 and bottom 38, which may be referred to as ends, are adapted for accepting the flexible cord 12 in an extended position 22 through passageway 44. The v-shaped elongated slot 20 is integrally formed from the tubular body 16 such that a base 46 of the v-shaped elongated slot 20 intersects the opening 40. In this configuration, the v-shaped elongated slot 40 operably accepts the flexible cord 12 in the folded position 24 and the apex 26 is adapted to bite the flexible cord 12. The span 48 of the v-shape elongated slot 20 decreases in width from the base 46 to the apex 26. In one implementation, the span 48 proximate to the base 46 is greater than or approximately equal to the diameter of the flexible cord 12 such that the v-shaped elongated slot 20 accepts the flexible cord 12. Further, the span 48 is tapered inwardly from the base 46 to the apex 26 such that proximate to the apex 26, the span 48 is substantially less than the diameter of the flexible cord 12.

The tubular body 18 includes a closed surface 50 on rear 34 opposite to the v-shaped elongated slot 20, which is positioned on the front 28. As will be discussed in further detail hereinbelow, the closed surface 50 may be coupled to another object to provide a further embodiment of the present invention. In one embodiment, the tubular body 16 comprises metal, but it should be appreciated that the tubular body may comprise any suitable material or combinations of materials including plastics and composites. Additionally, the tubular body 16 may include a cylinder shape. In one implementation, the v-shaped elongated slot 20 comprises a parabolic shape or a partially cut away parabolic section of the front 28 and the top 36 of the tubular body 16.

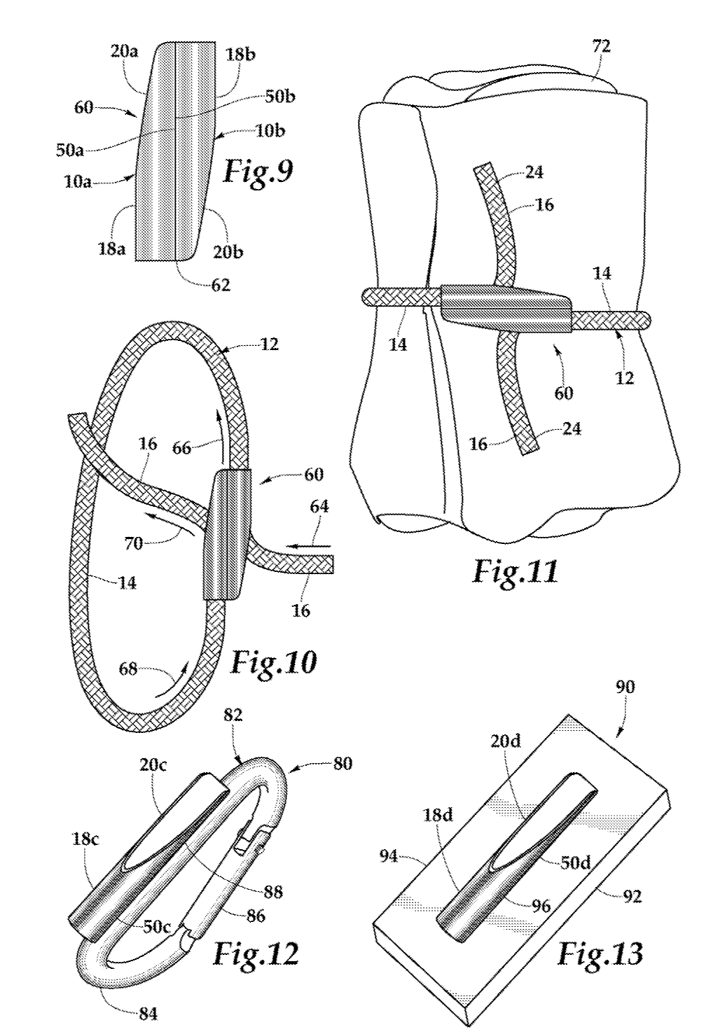

FIG. 9 depicts another embodiment of the adjustable clamp 60 wherein two adjustable clamps 10a, 10b are joined. The adjustable clamps 10a and 10b are substantially identical to the adjustable clamp 10 and reference letters “a” and “b” are used to refer to structures of the adjustable clamps 10a, 10b which are analogous to the aforementioned structures of the adjustable clamp 10. By way of example, the tubular bodies 18a, 18b of respective adjustable clamps 10a, 10b are each analogous to the tubular body 18 of the adjustable clamp 10.

The open ended tubular bodies 18a, 18b are each adapted for accepting a flexible cord 12 therethrough. Each of the tubular bodies 18a, 18b includes a respective v-shaped elongated slot 20a, 20b integrally formed therefrom. Additionally, closed surfaces 50a, 50b are positioned in contact and connected by a joint 62. Preferably, the tubular bodies 18a, 18b are integrally formed and the joint 62 is an immovable joint such that the tubular bodies 18a, 18b are interlocked and held together in a fixed position. As depicted, the tubular bodies 18a, 18b are positioned such that the v-shaped elongated slots 18a, 18b are facing opposite directions.

FIG. 10 depicts the adjustable clamp 60 being utilized with the flexible cord 12 which is threaded through the adjustable clamp 60 in a path sequentially defined by arrows 64, 66, 68, 70. Once the flexible cord 12 is threaded through the adjustable clamp 60, a user may then pull on the flexible cord in various directions to adjust the measures of usable cord 14 and excess cord 16. Once the exact length or desired measure of usable cord 14 is obtained, the measures of excess cord 16 are firmly anchored in the appropriate v-shaped slots 20a, 20b. In this manner, a user may control the amount of the flexible cord 12 at one or both ends of the flexible cord 12 or at any location therebetween. This feature is made possible by the opposing positions of the v-shaped elongated slots 20a, 20b which provide for controlling and releasably securing both ends of the flexible cord 12.

It should be appreciated that although the adjustable clamp 60 is depicted as being used with a single flexible cord, the adjustable clamp 60 may be employed with two flexible cords. Further, it should be appreciated that the flexible cord may include any elongated member whether a rope, a cord, a line, a braided line, a wire, or a string elongated member, for example.

FIG. 11 depicts the adjustable clamp 60 and the flexible cord 12 being utilized to secure cargo 72. More specifically, a single flexible cord 12 is threaded through the adjustable clamp 60 in a knot tee configuration while encircling the cargo 72. The flexible cord 12 loops around the cargo 72 and intersects at two approximate right angles such that the measures of excess cord 16 are disposed in folded positions 24 and releasably engaged with the v-shape elongated slots 20a, 20b and the flexible cord 12 is restrained and restricted. As seen in FIG. 11, to secure the cargo 72, the adjustable clamp 60 and the flexible cord 12 are only in contact with each other. The adjustable clamp 60 presented herein does not need to be attached to the cargo 72 or object being secured or to a third-object such as a cleat. Rather, the combination of the adjustable clamp 60 and the flexible cord 12 rely on the supplied tension of the flexible cord 12 to limit the length of the flexible cord 12 and secure the cargo 72. This feature is particularly useful when it is not practical or impossible to attach the flexible cord 12 to a fastener or other third-object.

FIG. 12 depicts a further embodiment of the adjustable clamp 10 which is generally referred to as adjustable clamp 80 and includes a tubular body 18c and a v-shaped elongated slot 20c which are respectively analogous to the tubular body 18 and the v-shaped elongated slot 20 of the adjustable clamp 10. As previously discussed, the tubular body 18c includes a closed surface 50c opposite to the v-shaped elongated slot 20c. As shown, the closed surface 50c is coupled to a carabiner 82 having a loop 84 and a gate 86. More specifically, the closed surface 50c is connected to the loop 84 by a joint 88, which, in one implementation, includes an immovable joint.

FIG. 13 depicts a still further embodiment of the adjustable clamp 10 which is generally designated as adjustable clamp 90. Continuing with the “a”, “b”, and “c” letter nomenclature for analogous structures utilized in FIGS. 9 through 12 and extending this nomenclature to “d” in FIG. 13, a tubular body 18d includes a closed surface 50d opposite to a v-shaped elongated slot 20d. The tubular body 18d is mounted to a mounting block 92 and, in particular, a surface 94 of the mounting block 92 and the closed surface 50d are immovably fixed there together by joint 96. The adjustable clamp 90 presented herein may be particularly useful in sailing and rigging applications where the mounting block 92 is affixed to a portion of a ship or boat, for example.

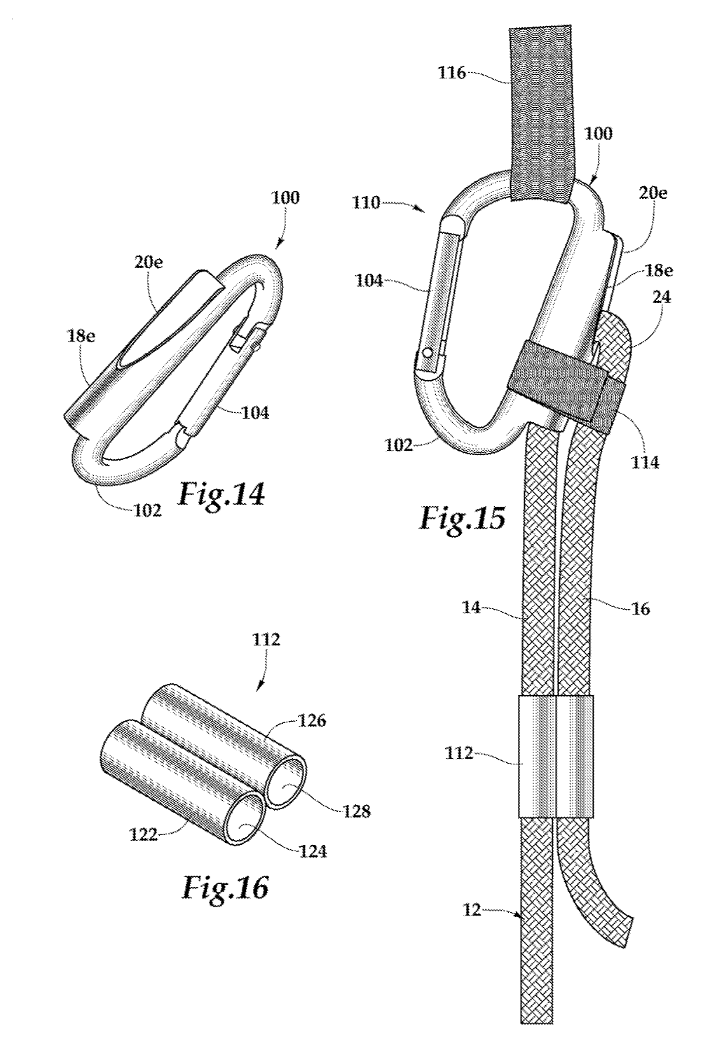

FIG. 14 depicts another embodiment of the adjustable clamp 10 which is generally referred to as adjustable clamp-carabiner 100. A tubular body 18e and a v-shaped elongated slot 20e are respectively analogous to the tubular body 18 and the v-shaped elongated slot 20. In this embodiment, the tubular body 18e and the v-shaped elongated slot 20e integrally form a portion of a loop 102 opposite to a gate 104. With this arrangement, the tubular body 18e creates the backbone of the loop 102 of the adjustable clamp-carabiner 100. It should be appreciated that the tubular body 18e may be more or less integrated with the loop 102 than depicted in FIG. 14.

FIG. 15 depicts one embodiment of an adjustable clamp system 110 which provides for varying the length and grooming the flexible cord 12, which as previously discussed, includes the measure of usable cordage 14 and the measure of excess cordage 16. The adjustable clamp-carabiner 100 includes the open ended tubular 18e which forms a portion of the loop 102. The open ended tubular body 18e, which has the v-shaped elongated slot 20e integrally formed therein, accepts the flexible cord 12 therethrough such that the measure of usable cordage 14 and the measure of excess cordage 16 are on opposing ends of the open ended tubular body 18e.

As depicted, the v-shaped elongated slot 20e releasably engages the measure of excess cordage 16 of the flexible cord 12 therein, thereby doubling the measure of excess cordage 16 upon the measure of usable cordage 14. That is, the flexible cord is disposed in the folded position 24. A double-barreled stop 112 slidably secured by a friction fit grooms the flexible cord 12 by accepting each of the measure of usable cordage 14 and the measure of excess cordage 16 therethrough. Accordingly, the measure of usable cordage 14 and the measure of excess cordage 16 are secured at two locations; namely, the v-shaped elongated slot 20e and the double-barreled stop 112.

In instances where the flexible cord 12 includes a braided line and the excess cordage 16 must be doubled upon itself, a clamping means 114, such as a VELCRO® implement, a clip, tie, or c-shape clamp, for example, which is connected to the tubular body 18e and the loop 102, may be utilized to position and hold the doubled excess cordage 16 in place, which is the part of the flexible cord 12 that has been turned approximately 180° and rotated upon itself. A tightening loop 116, which may include a synthetic fiber construction, coupled to the loop 102 of the adjustable clamp-carabiner 100 may also be employed with the system 110 as a hand hold. The tightening loop 116, in response to a pulling force, causes the v-shaped elongated slot 20e to engage the measure of excess cordage 16 of the flexible cord 12, thereby causing or increasing the grip therebetween. More specifically, as the flexible cord 12 is tightened, the v-shaped slot 20e and the excess cord 16 need to be pulled in opposite directions and the tightening loop 116 assists in accomplishing this by applying the necessary leverage. It should be understood that the additional components of the clamping means 114 and the tightening loop 116 may be used with the system 110 with any type of flexible cord 12. Further, it should be appreciated that although the adjustable clamp-carabiner 100 embodiment is depicted, other embodiments of the adjustable clamp may be utilized with the system 110. By way of example, the adjustable clamp 80 embodiment of FIG. 12 may be utilized.

FIG. 16 depicts the double-barreled stop 112 in further detail, which “dolly-ups” the flexible cord 12. A barrel 122 having a channel 124 therethrough is joined to a barrel 126 having a channel 128 therethrough. Each of the channels 124, 128 provide a passage for the flexible cord 12 and each of the barrels 122, 126 may be flared at the openings to provide for easy threading of the flexible cord 12. For example, the channel 124 is adapted to accept the measure of usable cordage 14 while the channel 126 is adapted to accept the measure of excess cordage 16 or visa versa. In one implementation, each of the barrels 122, 126 comprises a metal, synthetic, or composite material having a diameter proximate to the diameter of the flexible cord 12 so that a friction fit may be established therewith and the measure of usable cordage 14 and the measure of excess cordage 16 may be kept aligned.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. An adjustable clamp comprising:
a tubular body having first and second openings at respective first and second ends, the tubular body adapted for accepting a flexible cord in an extended position therethrough;
a v-shaped elongated slot integrally formed from the tubular body;
a base of the v-shaped elongated slot intersecting the first opening such that the v-shaped elongated slot operably accepts the flexible cord in a folded position; and
an apex of the v-shaped elongated slot adapted to bite the flexible cord when the flexible cord is displaced from the extended position to the folded position.

2. The adjustable clamp as recited in claim 1, wherein the tubular body further comprises a closed surface opposite to the v-shaped elongated slot.

3. The adjustable clamp as recited in claim 2, wherein the closed surface is coupled to a loop of a carabiner.

4. The adjustable clamp as recited in claim 2, wherein the closed surface is coupled to a surface of a mounting plate.

5. The adjustable clamp as recited in claim 1, wherein the tubular body forms a portion of a loop of a carabiner.

6. The adjustable clamp as recited in claim 1, wherein the tubular body comprises a cylinder shape.

7. The adjustable clamp as recited in claim 1, wherein the v-shaped elongated slot comprises a parabolic shape.

8. The adjustable clamp as recited in claim 1, wherein the flexible cord comprises a cord selected from the group consisting of bungee cords and braided lines.

9. The adjustable clamp as recited in claim 1, wherein upon bitting the flexible cord, the v-shape elongated slot shortens a usable length of the flexible cord.

10. The adjustable clamp as recited in claim 1, wherein upon bitting the flexible cord, the v-shape elongated slot secures the flexible cord against elongated movement at the apex.

11. A combination of an adjustable clamp and a flexible bungee cord, the combination comprising:
a flexible cord having a measure of usable cordage;
an open ended tubular body adapted to accept the flexible cord therethrough; and
a v-shaped elongated slot integrally formed from the tubular body, the v-shaped elongated slot operable to releasably engage the flexible cord therein, thereby reducing the measure of usable cordage.

12. The combination as recited in claim 11, wherein the flexible cord comprises an extended position that permits the flexible cord to travel through the open ended tubular body.

13. The combination as recited in claim 11, wherein the flexible cord comprises a folded position that releasably engages the v-shaped elongated slot and restricts the movement of the flexible cord through the open ended tubular body.

14. The combination as recited in claim 11, wherein the v-shaped elongated slot comprises a partially cut away parabolic section of the open ended tubular body.

15. An adjustable clamp comprising:
a first open ended tubular body adapted for accepting a flexible cord in an extended position therethrough, the first open ended tubular body including a first v-shaped elongated slot integrally formed from the first open ended tubular body and a first closed surface opposite to the first v-shaped elongated slot;
a second open ended tubular body adapted for accepting the flexible cord in an extended position therethrough, the second open ended tubular body including a second v-shaped elongated slot integrally formed from the second open ended tubular body and a second closed surface opposite to the second v-shaped elongated slot; and
a joint coupling the first closed surface of the first open ended tubular body to the second closed surface of the second open ended tubular body such that the first v-shaped elongated slot and the second v-shaped elongated slot face opposite directions.

16. A method for using an adjustable clamp and a flexible bungee cord, the method comprising:
threading the flexible bungee cord through an open ended tubular body of the adjustable clamp adapted to accept the flexible cord therethrough, the open ended tubular body including a v-shaped elongated slot integrally formed therein;
providing a measure of usable cordage of the flexible bungee cord at a first end opposite to the v-shaped elongated slot;
folding a portion of the flexible bungee cord at a second end proximate to the v-shaped elongated slot from an extended position to a folded position; and
releasably engaging the potion of the flexible bungee cord in the v-shaped elongated slot, thereby fixing the measure of usable cordage.

17. The method as recited in claim 16, further comprising releasing the flexible bungee cord from the v-shaped elongated slot, thereby freeing the measure of usable cordage.

18. The method as recited in claim 16, further comprising:
pulling the measure of usable cordage; and
increasing the engagement between the portion of the flexible bungee cord and the v-shaped elongated slot.

19. The method as recited in claim 16, further comprising, prior to folding a portion of the flexible bungee cord, adjusting the measure of usable cordage by sliding the flexible bungee cord through the open ended tubular body.

20. The method as recited in claim 16, wherein releasably engaging the portion of the flexible bungee cord further comprises pressing the potion of the flexible bungee cord into the v-shaped elongated slot such that the v-shaped elongated slot bites the portion of the flexible bungee cord.

21. An adjustable clamp system comprising:
a flexible cord having a measure of usable cordage and a measure of excess cordage;
a carabiner including a loop having a gate;
an open ended tubular body coupled to the loop of the carabiner, the open ended tubular body accepting the flexible cord therethrough such that the measure of usable cordage and the measure of excess cordage are on opposing ends of the open ended tubular body;
a v-shaped elongated slot integrally formed from the open ended tubular body, the v-shaped elongated slot releasably engaging the measure of excess cordage of the flexible cord therein, thereby doubling the measure of excess cordage upon the measure of usable cordage; and
a double-barreled stop slidably secured by a friction fit to each of the measure of usable cordage and the measure of excess cordage.

22. The adjustable clamp system as recited in claim 21, wherein the open ended tubular body forms a portion of the loop of the carabiner.

23. The adjustable clamp system as recited in claim 21, wherein the flexible cord further comprises a braided line having the excess cordage doubled upon the measure of usable cordage by a clamping means which is connected to the open ended tubular body.

24. The adjustable clamp system as recited in claim 21, further comprising a tightening loop coupled to the loop of the carabiner, the tightening loop, in response to a pulling force, the v-shaped elongated slot engages the measure of excess cordage of the flexible cord.
